(19) United States
(12) Patent Application Publication
(10) Pub. No.: US 2026/0229478 A1
(43) Pub. Date: Aug. 6, 2026

(54) ION SEPARATOR

(71) Applicant: Micromass UK Limited, Wilmslow (GB)

(72) Inventors: Martin Raymond Green, Bowden (GB); Keith George Richardson, High Peak (GB)

(73) Assignee: Micromass UK Limited, Wilmslow (GB)

(21) Appl. No.: 19/633,025

(22) Filed: Mar. 30, 2026

Related U.S. Application Data
(63) Continuation of application No. 18/346,631, filed on Jul. 3, 2023, now abandoned.
Application No. 18/346,631 is a continuation of application No. 16/341,049, filed on Oct. 19, 2017, now abandoned.

(30) Foreign Application Priority Data
Oct. 19, 2016 (GB) 1617710.7

(51) Int. Cl. H01J 49/42; G01N 27/623; H01J 49/00

(52) U.S. Cl. CPC H01J 49/4235; G01N 27/623; H01J 49/0031; H01J 49/427; H01J 49/004

(57) ABSTRACT

A method of separating ions is disclosed comprising: providing an ion separation device comprising a plurality of electrodes; providing a gas flow (5) so as to urge ions in a first direction along the device; applying voltages to said electrodes so that a plurality of travelling potentials (4) urge the ions in a second opposite direction; and varying at least one operational parameter of the travelling potentials (4) as a function of position along the device such that ions of different mobility or mass to charge ratio become trapped at different locations along the device.

### CROSS-REFERENCE TO RELATED APPLICATIONS

This application is a continuation application of U.S. patent application Ser. No. 18/346,631, filed Jul. 3, 2023, which is a continuation application of U.S. patent application Ser. No. 16/341,049, filed Apr. 10, 2019, now abandoned, which is the U.S. National Stage of International Patent Application No. PCT/GB2017/053165, filed Oct. 19, 2017, which claims priority from and the benefit of United Kingdom Patent Application No. 1617710.7, filed Oct. 19, 2016. The entire contents of these applications are incorporated herein by reference.

### FIELD OF THE INVENTION

The present invention relates generally to mass and/or ion mobility spectrometers and in particular to spectrometers that separate ions by ion mobility and/or mass to charge ratio.

### BACKGROUND

WO 2015/097462 describes an instrument that separates ions by using a gas flow to drive ions towards an exit and driving ions towards the entrance with a DC travelling wave. A DC barrier is provided at the entrance end of the device so as to trap ions for which the drive from the travelling wave overcomes the drive from the gas flow. Ions are sequentially released from this trapping region in reverse order of mobility, by reducing the amplitude of the travelling wave.

It is desired to provide an improved method of separating ions and an improved spectrometer.

### SUMMARY

From a first aspect, the present invention provides a method of separating ions comprising: providing an ion separation device comprising a plurality of electrodes; providing a gas flow so as to urge ions in a first direction along the device; applying voltages to said electrodes so that a plurality of travelling potentials move along the device and urge the ions in a second direction opposite to the first direction whilst the ions are being urged by the gas in the first direction, wherein at least one operational parameter of the travelling potentials is varied as a function of position along the second direction such that ions of different mobility or mass to charge ratio become trapped within a trapping region at different locations along the second direction; and sequentially releasing ions from said trapping region in increasing order of ion mobility or mass to charge ratio, or in decreasing order of ion mobility or mass to charge ratio.

The combination of the step of urging the ions in the first direction and also urging these ions in the second direction causes the ions to be trapped in the trapping region. As one or more operational parameters of the traveling potential vary along the second direction, different ions become trapped at different locations in the second direction along the trapping region. This provides the device with a relatively high space-charge capacity. Also, the one or more operational parameters of the traveling potential may vary along the second direction such that the driving force on ions at an end of the device is relatively low. This may be used to prevent ions being driven into electrodes and lost or being driven into RF confinement fields and being heated.

One of the at least one operational parameters may be the maximum amplitude of the travelling potentials, which reduces or increases as the potentials move along the device in the second direction.

A plurality of travelling potentials having different maximum amplitudes may be simultaneously located along the trapping region.

The maximum amplitude of the travelling potentials may reduce or increase monotonically as the potentials move along the device in the second direction.

One of the at least one operational parameters may be the speed of the travelling potentials, which increases or decreases as a function of position along the device in the second direction. Alternatively, or additionally, one of the at least one operational parameters may be the frequency with which the travelling potentials pass along the device, which may increase or decrease as a function of position along the device in the second direction. Alternatively, or additionally, one of the at least one operational parameters may be the duty cycle and/or length of the travelling potentials in the second direction, which may increase or decrease as a function of position along the device in the second direction. Alternatively, or additionally, one of the at least one operational parameters may be the shape of the travelling potentials, which may change as the potentials move along the device in the second direction. It will be appreciated that any one of the above listed techniques may be varied simultaneously as a function of position along the second direction such that ions of different mobility or mass to charge ratio become trapped within a trapping region at different locations along the second direction. Alternatively, a combination of any (i.e. any two, any three, any four or any five) of the listed techniques may be used.

As described above, the duty cycle of the travelling potentials may change as the potentials move along the device in the second direction. The duty cycle may be defined as the ratio of the length (in the second direction) or time over which the magnitude of the travelling potential is high (e.g. at the maximum amplitude) to the length (in the second direction) or time over which the magnitude of the travelling potential is low. For example, the duty cycle of a travelling DC potential with a substantially square wave profile may be defined by the ratio of the length or time over which the magnitude of the potential is high to the length or time over which the magnitude of the potential is low. The duty cycle may be varied without altering the overall cycle time, frequency or speed of the travelling DC potential waveform. It is contemplated that the travelling DC potential waveform may be generated with a profile other than a simple square wave and may still be varied in duty cycle without changing the cycle time, frequency or speed of the waveform.

As described above, the shape of the travelling potentials may change as the potentials move along the device in the second direction. For example, the peaks of the potentials may become more or less square, more or less triangular, more or less Gaussian, or change from any one of these shapes to another of these shapes as the potentials move along the device.

The ions may be released in order, or reverse order, along the first direction or along the second direction. Alternatively, it is contemplated that the separated ions may be ejected in a direction orthogonal to the first and/or second directions, e.g. in a radial direction.

The first direction may extend from an ion entrance of the device to an ion exit of the device, and the second direction may extend from the ion exit to the ion entrance. Alternatively, the first direction may extend from an ion exit of the device to an ion entrance of the device, and the second direction may extend from the ion entrance to the ion exit.

The step of applying voltages may comprise applying DC transient voltages to the electrodes, wherein the travelling potentials are DC travelling potentials.

Alternatively, and less desirably, said step of applying voltages comprises applying different phases of an AC or RF voltage supply to different ones of said electrodes, and said travelling potentials are pseudo-potentials.

The step of urging ions in the first direction and the step of providing the travelling potentials may cause ions to become trapped so that the mobilities or the mass to charge ratios of the ions either increase or decrease with increasing position in the second direction.

The method disclosed herein may comprise generating ions in an ion source and providing the ions to the trapping region.

Ions may be caused to enter the trapping region by entraining the ions in the gas flow.

The step of sequentially releasing ions may be performed by increasing or decreasing the gas flow rate as a function of time such that the ions are sequentially released from the trapping region at different times and in order of ion mobility or mass to charge ratio, or in reverse order of ion mobility or mass to charge ratio.

One or more operational parameter of the travelling potentials may be varied with time such that the trapping location of any given ion correspondingly varies with time, or such that ions are selectively ejected from the trapping region or from the device as a function of time (e.g. according to mobility or mass to charge ratio).

Accordingly, the step of sequentially releasing ions may be performed by reducing or increasing the maximum amplitude of the travelling potentials as a function of time and so that the maximum amplitude occurring at a given location along the trapping region is reduced or increased with time respectively.

The step of sequentially releasing ions may be performed by any one or more of: (i) reducing or increasing the speed of the travelling potentials as a function of time such that the speed occurring at a given location along the trapping region is reduced or increased with time respectively; and/or (ii) reducing or increasing the frequency with which the travelling potentials pass along the device as a function of time such that the frequency occurring at a given location along the trapping region is reduced or increased with time respectively; and/or (iii) reducing or increasing the duty cycle and/or length of the travelling potentials in the second direction as a function of time so that the duty cycle and/or length occurring at a given region along the trapping region is reduced or increased with time respectively; and/or (iv) varying the shape of the travelling potentials occurring at a given region along the trapping region as a function of time.

The method may vary the amplitude and/or speed and/or frequency and/or duty cycle and/or length of the travelling potentials as they move along the device such that the amplitude and/or speed and/or frequency and/or duty cycle and/or length decrease as the travelling potential approaches the barrier.

It will be appreciated that any one of the above listed techniques may be used to sequentially release the ions. Alternatively, a combination of any (i.e. any two, any three, any four or any five) of the listed techniques may be used.

The operational parameter may be scanned (e.g. progressively and continuously varied with time) or stepped with time so as to sequentially release the ions.

The method disclosed herein may comprise providing a DC or pseudo-potential barrier at an ion entrance end and/or ion exit end of the trapping region.

The method may comprise confining ions orthogonally to the first and second directions, optionally by applying AC or RF voltages to electrodes.

The method may comprise performing a first mode of operation in which said travelling potentials are translated along the trapping region with a first speed so as to cause ions to be separated according to their ion mobilities; and performing a second mode of operation in which said travelling potentials are translated along the trapping region with second speed that is higher than said first speed so as to cause ions to be separated according to their mass to charge ratios.

The method may also comprise increasing the amplitude of the travelling potentials when switching from the first mode to the second mode.

The methods may cause ions to exit the device in order of increasing or decreasing mobility or mass to charge ratio. The method may comprise: transmitting the ions, whilst separated, from the separation device to a downstream ion analyser; and varying the operation of the ion analyser as a function of time, based on and in synchronism with the mass to charge ratios of the ions exiting the separation device and being received at the ion analyser.

The ion analyser may comprises an ion filter that only transmits ions having a certain value or range of values of mobility or mass to charge ratio at any given time, and the value or range of values transmitted by the ion filter may be varied with time in based on and in synchronism with the mobilities or mass to charge ratios of the ions exiting the device and being received at the ion analyser.

The ion analyser may be a discontinuous ion analyser that receives ions from the separation device and repeatedly pulses ions into an analysis region; and the duration of time between the pulses may be varied as a function of time, based on and in synchronism with the mobilities or mass to charge ratios of the ions exiting the separation device and being received at the ion analyser; or the duration of time between any given ion exiting the device and being pulsed into the analysis region may be varied as a function of time, based on and in synchronism with the mobilities or mass to charge ratios of the ions exiting the device and being received at the ion analyser.

The ion analyser may be a mass analyser such as a Time of Flight mass analyser and the analysis region may be a Time of Flight region.

The method may comprise separating ions having the same mass to charge ratio but differing ion mobilities in the first mode; and/or separating ions having the same ion mobility but differing mass to charge ratios in the second mode.

In the first mode, the travelling potentials and the opposing force may cause the ions to reach their terminal velocities; wherein in the second mode the ions may not be caused to reach their terminal velocities.

The method may switch between said first and second modes (e.g. repeatedly), optionally whilst analysing the same sample in a single experimental run.

The present invention also provides a method of mass and/or ion mobility spectrometry comprising: separating ions according to the method disclosed herein; and detecting, filtering or mass analysing the ions released from the trapping region.

The first aspect of the present invention also provides a separation device for separating ions, comprising: a plurality of electrodes; one or more voltage supplies;
a first ion urging device configured and set up to provide a gas flow for urging ions in a first direction along the device; and a controller configured and set up to control the one or more voltage supplies so as to apply voltages to said electrodes so that, in use, a plurality of travelling potentials move along the device and urge ions in a second direction opposite to the first direction whilst the ions are being urged by the gas flow in the first direction, wherein the controller is configured and set up to vary at least one operational parameter of the travelling potentials as a function of position along the second direction such that, in use, ions of different mobility or mass to charge ratio become trapped within a trapping region at different locations along the second direction.

The controller may be configured and set up to vary the gas flow and/or operational parameter with time so as to sequentially release ions from said trapping region in increasing order of ion mobility or mass to charge ratio, or in decreasing order of ion mobility or mass to charge ratio.

The separation device may be configured and set up to perform any of the methods described herein.

The present invention also provides a mass spectrometer and/or ion mobility spectrometer comprising: a separation device as described herein, wherein the controller is configured and set up to release or eject ions from the trapping region; and a detector, ion filter or mass analyser arranged to detect, filter or mass analyse the ions.

It is also contemplated herein that a DC voltage gradient or DC electric field may be used to urge ions in the first direction along the device instead of a gas flow.

Accordingly, from a second aspect the present invention provides a method of separating ions comprising: providing an ion separation device comprising a plurality of electrodes; providing a DC voltage gradient or DC electric field so as to urge ions in a first direction along the device; applying voltages to said electrodes so that a plurality of travelling potentials move along the device and urge the ions in a second direction opposite to the first direction whilst the ions are being urged by the DC voltage gradient or DC electric field in the first direction; wherein the magnitude of the DC voltage gradient or DC electric field is varied as a function of position along the first direction and/or wherein at least one operational parameter of the travelling potentials is varied as a function of position along the second direction, such that ions of different mobility or mass to charge ratio become trapped within a trapping region at different locations along the first and second directions; and sequentially releasing ions from said trapping region in increasing order of ion mobility or mass to charge ratio, or in decreasing order of ion mobility or mass to charge ratio.

The second aspect of the present invention may have any of the features of the first aspect of the invention, except that the gas flow is replaced by the DC gradient or DC electric field. For example, in the embodiments wherein the at least one operational parameter of the traveling potential varies along the second direction, the operational parameter(s) may vary as described herein above in relation to the first aspect of the present invention.

Ions may be sequentially released from the trapping region by varying the magnitude of the DC gradient or DC field with time and/or by varying one or more operational parameter of the travelling potential with time (in a corresponding manner to that described above in relation to the first aspect of the present invention).

The second aspect of the present invention provides a corresponding separation device.

Accordingly, the second aspect provides a separation device for separating ions, comprising: a plurality of electrodes; one or more voltage supplies; and a controller configured and set up to control the one or more voltage supplies so as to apply voltages to said electrodes so that, in use, a DC voltage gradient or DC electric field urges ions in a first direction along the device and a plurality of travelling potentials move along the device and urge ions in a second direction opposite to the first direction whilst the ions are being urged by the DC voltage gradient or DC electric field in the first direction; wherein the controller is configured and set up to vary the magnitude of the DC voltage gradient or DC electric field as a function of position along the first direction and/or to vary at least one operational parameter of the travelling potentials as a function of position along the second direction, such that in use ions of different mobility or mass to charge ratio become trapped within a trapping region at different locations along the second direction.

The device of the second aspect of the invention may be configured and set up to perform any of the methods according to the second aspect of the invention.

The spectrometer disclosed herein may comprise an ion source selected from the group consisting of: (i) an Electrospray ionisation (“ESI”) ion source; (ii) an Atmospheric Pressure Photo Ionisation (“APPI”) ion source; (iii) an Atmospheric Pressure Chemical Ionisation (“APCI”) ion source; (iv) a Matrix Assisted Laser Desorption Ionisation (“MALDI”) ion source; (v) a Laser Desorption Ionisation (“LDI”) ion source; (vi) an Atmospheric Pressure Ionisation (“API”) ion source; (vii) a Desorption Ionisation on Silicon (“DIOS”) ion source; (viii) an Electron Impact (“EI”) ion source; (ix) a Chemical Ionisation (“CI”) ion source; (x) a Field Ionisation (“FI”) ion source; (xi) a Field Desorption (“FD”) ion source; (xii) an Inductively Coupled Plasma (“ICP”) ion source; (xiii) a Fast Atom Bombardment (“FAB”) ion source; (xiv) a Liquid Secondary Ion Mass Spectrometry (“LSIMS”) ion source; (xv) a Desorption Electrospray Ionisation (“DESI”) ion source; (xvi) a Nickel-63 radioactive ion source; (xvii) an Atmospheric Pressure Matrix Assisted Laser Desorption Ionisation ion source; (xviii) a Thermospray ion source; (xix) an Atmospheric Sampling Glow Discharge Ionisation (“ASGDI”) ion source; (xx) a Glow Discharge (“GD”) ion source; (xxi) an Impactor ion source; (xxii) a Direct Analysis in Real Time (“DART”) ion source; (xxiii) a Laserspray Ionisation (“LSI”) ion source; (xxiv) a Sonicspray Ionisation (“SSI”) ion source; (xxv) a Matrix Assisted Inlet Ionisation (“MAII”) ion source; (xxvi) a Solvent Assisted Inlet Ionisation (“SAII”) ion source; (xxvii) a Desorption Electrospray Ionisation (“DESI”) ion source; (xxviii) a Laser Ablation Electrospray Ionisation (“LAESI”) ion source; and (xxix) Surface Assisted Laser Desorption Ionisation (“SALDI”).

The spectrometer may comprise one or more continuous or pulsed ion sources.

The spectrometer may comprise one or more ion guides.

The spectrometer may comprise one or more ion mobility separation devices and/or one or more Field Asymmetric Ion Mobility Spectrometer devices.

The spectrometer may comprise one or more collision, fragmentation or reaction cells selected from the group consisting of: (i) a Collisional Induced Dissociation (“CID”) fragmentation device; (ii) a Surface Induced Dissociation (“SID”) fragmentation device; (iii) an Electron Transfer Dissociation (“ETD”) fragmentation device; (iv) an Electron Capture Dissociation (“ECD”) fragmentation device; (v) an Electron Collision or Impact Dissociation fragmentation device; (vi) a Photo Induced Dissociation (“PID”) fragmentation device; (vii) a Laser Induced Dissociation fragmentation device; (viii) an infrared radiation induced dissociation device; (ix) an ultraviolet radiation induced dissociation device; (x) a nozzle-skimmer interface fragmentation device; (xi) an in-source fragmentation device; (xii) an in-source Collision Induced Dissociation fragmentation device; (xiii) a thermal or temperature source fragmentation device; (xiv) an electric field induced fragmentation device; (xv) a magnetic field induced fragmentation device; (xvi) an enzyme digestion or enzyme degradation fragmentation device; (xvii) an ion-ion reaction fragmentation device; (xviii) an ion-molecule reaction fragmentation device; (xix) an ion-atom reaction fragmentation device; (xx) an ion-metastable ion reaction fragmentation device; (xxi) an ion-metastable molecule reaction fragmentation device; (xxii) an ion-metastable atom reaction fragmentation device; (xxiii) an ion-ion reaction device for reacting ions to form adduct or product ions; (xxiv) an ion-molecule reaction device for reacting ions to form adduct or product ions; (xxv) an ion-atom reaction device for reacting ions to form adduct or product ions; (xxvi) an ion-metastable ion reaction device for reacting ions to form adduct or product ions; (xxvii) an ion-metastable molecule reaction device for reacting ions to form adduct or product ions; (xxviii) an ion-metastable atom reaction device for reacting ions to form adduct or product ions; and (xxix) an Electron Ionisation Dissociation (“EID”) fragmentation device.

The spectrometer may comprise a mass analyser selected from the group consisting of: (i) a quadrupole mass analyser; (ii) a 2D or linear quadrupole mass analyser; (iii) a Paul or 3D quadrupole mass analyser; (iv) a Penning trap mass analyser; (v) an ion trap mass analyser; (vi) a magnetic sector mass analyser; (vii) Ion Cyclotron Resonance (“ICR”) mass analyser; (viii) a Fourier Transform Ion Cyclotron Resonance (“FTICR”) mass analyser; (ix) an electrostatic mass analyser arranged to generate an electrostatic field having a quadro-logarithmic potential distribution; (x) a Fourier Transform electrostatic mass analyser; (xi) a Fourier Transform mass analyser; (xii) a Time of Flight mass analyser; (xiii) an orthogonal acceleration Time of Flight mass analyser; and (xiv) a linear acceleration Time of Flight mass analyser.

The spectrometer may comprise one or more energy analysers or electrostatic energy analysers.

The spectrometer may comprise one or more ion detectors.

The spectrometer may comprise one or more mass filters selected from the group consisting of: (i) a quadrupole mass filter; (ii) a 2D or linear quadrupole ion trap; (iii) a Paul or 3D quadrupole ion trap; (iv) a Penning ion trap; (v) an ion trap; (vi) a magnetic sector mass filter; (vii) a Time of Flight mass filter; and (viii) a Wien filter.

The spectrometer may comprise a device or ion gate for pulsing ions; and/or a device for converting a substantially continuous ion beam into a pulsed ion beam.

The spectrometer may comprise a stacked ring ion guide comprising a plurality of electrodes each having an aperture through which ions are transmitted in use and wherein the spacing of the electrodes increases along the length of the ion path, and wherein the apertures in the electrodes in an upstream section of the ion guide have a first diameter and wherein the apertures in the electrodes in a downstream section of the ion guide have a second diameter which is smaller than the first diameter, and wherein opposite phases of an AC or RF voltage are applied, in use, to successive electrodes.

The spectrometer may comprise a device arranged and adapted to supply an AC or RF voltage to the electrodes. The AC or RF voltage optionally has an amplitude selected from the group consisting of: (i) about <50 V peak to peak; (ii) about 50-100 V peak to peak; (iii) about 100-150 V peak to peak; (iv) about 150-200 V peak to peak; (v) about 200-250 V peak to peak; (vi) about 250-300 V peak to peak; (vii) about 300-350 V peak to peak; (viii) about 350-400 V peak to peak; (ix) about 400-450 V peak to peak; (x) about 450-500 V peak to peak; and (xi)>about 500 V peak to peak.

The AC or RF voltage may have a frequency selected from the group consisting of: (i)<about 100 kHz; (ii) about 100-200 kHz; (iii) about 200-300 kHz; (iv) about 300-400 kHz; (v) about 400-500 kHz; (vi) about 0.5-1.0 MHz; (vii) about 1.0-1.5 MHz; (viii) about 1.5-2.0 MHz; (ix) about 2.0-2.5 MHz; (x) about 2.5-3.0 MHz; (xi) about 3.0-3.5 MHz; (xii) about 3.5-4.0 MHz; (xiii) about 4.0-4.5 MHz; (xiv) about 4.5-5.0 MHz; (xv) about 5.0-5.5 MHz; (xvi) about 5.5-6.0 MHz; (xvii) about 6.0-6.5 MHz; (xviii) about 6.5-7.0 MHz; (xix) about 7.0-7.5 MHz; (xx) about 7.5-8.0 MHz; (xxi) about 8.0-8.5 MHz; (xxii) about 8.5-9.0 MHz; (xxiii) about 9.0-9.5 MHz; (xxiv) about 9.5-10.0 MHz; and (xxv)>about 10.0 MHz.

The spectrometer may comprise a chromatography or other separation device upstream of an ion source. The chromatography separation device may comprise a liquid chromatography or gas chromatography device. Alternatively, the separation device may comprise: (i) a Capillary Electrophoresis (“CE”) separation device; (ii) a Capillary Electrochromatography (“CEC”) separation device; (iii) a substantially rigid ceramic-based multilayer microfluidic substrate (“ceramic tile”) separation device; or (iv) a supercritical fluid chromatography separation device.

The ion guide may be maintained at a pressure selected from the group consisting of: (i)<about 0.0001 mbar; (ii) about 0.0001-0.001 mbar; (iii) about 0.001-0.01 mbar; (iv) about 0.01-0.1 mbar; (v) about 0.1-1 mbar; (vi) about 1-10 mbar; (vii) about 10-100 mbar; (viii) about 100-1000 mbar; and (ix)>about 1000 mbar.

Analyte ions may be subjected to Electron Transfer Dissociation (“ETD”) fragmentation in an Electron Transfer Dissociation fragmentation device. Analyte ions may be caused to interact with ETD reagent ions within an ion guide or fragmentation device.

The spectrometer may be operated in various modes of operation including a mass spectrometry (“MS”) mode of operation; a tandem mass spectrometry (“MS/MS”) mode of operation; a mode of operation in which parent or precursor ions are alternatively fragmented or reacted so as to produce fragment or product ions, and not fragmented or reacted or fragmented or reacted to a lesser degree; a Multiple Reaction Monitoring (“MRM”) mode of operation; a Data Dependent Analysis (“DDA”) mode of operation; a Data Independent Analysis (“DIA”) mode of operation a Quantification mode of operation or an Ion Mobility Spectrometry (“IMS”) mode of operation.

### BRIEF DESCRIPTION OF THE DRAWINGS

Various embodiments will now be described, by way of example only, and with reference to the accompanying drawings in which:

FIG. 1A shows a schematic of a prior art ion separator and FIG. 1B shows a schematic of the DC voltages that may be applied to the device of FIG. 1A at any one moment in time;

FIG. 2A shows a schematic representing the DC travelling potentials along a device according to an embodiment of the invention during an ion trapping mode, and FIG. 2B shows a schematic representing the DC travelling potentials along the device of FIG. 2A during an ion release mode;

FIG. 3 shows an example profile of the DC travelling potentials according to an embodiment of the invention;

FIG. 4 shows plots for two types of ions having different mobilities and masses, wherein each plot represents the positions of the ions within a device according to an embodiment of the invention as a function of time after the ions enter the device;

FIG. 5 shows two plots obtained using the same parameters as those for FIG. 4, except wherein the two plots overlap as the two types of ions have different masses but the same mobilities;

FIG. 6 shows plots obtained using the same parameters and ions as those for FIG. 5, except wherein the speed of the travelling potential has been increased such that the positions of the two different ions are resolved;

FIG. 7 shows a simulation of an embodiment corresponding to that of FIG. 4, except wherein a second region is provided downstream and the amplitudes of the DC travelling potentials are scanned with time so as to eject ions from the device;

FIG. 8 shows a schematic of a less preferred embodiment in which the direction of travel of the DC travelling potentials is towards the exit of the device;

FIGS. 9A-9C show embodiments of the electrodes that may be used to form the ion separator;

FIG. 10 shows a schematic representing the DC travelling potentials along a device according to an embodiment for extending the space-charge capacity for a subset of ion mobilities; and

FIG. 11 shows a schematic representing the DC travelling potentials along a device according to an embodiment for partitioning ions having two groups of ion mobility.

### DETAILED DESCRIPTION

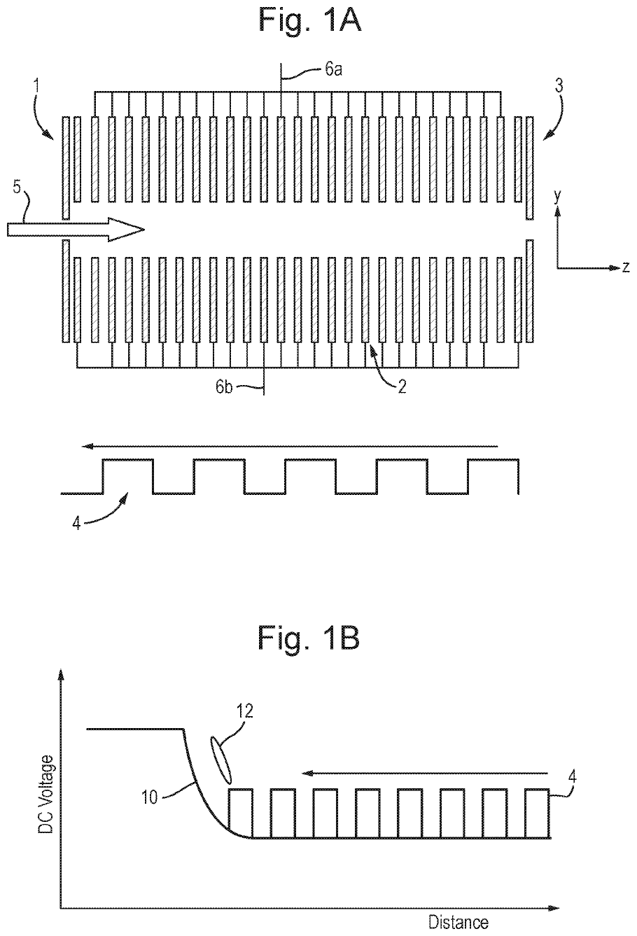

FIG. 1A shows a schematic of an ion separator according to WO 2015/097462. The separator comprises a plurality of electrodes spaced along a longitudinal axis of the separator, each electrode having an aperture through which ions are transmitted in use. The device comprises an entrance electrode 1, a series of intermediate ring electrodes 2 and an exit electrode 3. Opposite phases 6a,6b of an AC potential oscillating at RF frequency are applied to alternate ring electrodes 2 in order to produce a pseudo-potential that confines the ions radially.

In operation ions may be urged in a direction from the entrance end 1 of the device towards the exit end 3 of the device by applying a gas flow 5 through the device. Transient DC voltages are applied to the electrodes 2 such that DC potentials 4 travel along the device so as to urge ions in a direction from the from the exit end of the device towards the entrance end of the device. Initially, the amplitude and velocity of the DC travelling potentials are arranged such that the travelling DC potentials do not allow the ions of interest to pass the travelling DC potentials, and hence these ions are driven towards the entrance of the device. Ions are effectively trapped with substantially no separation near to the entrance of the device by a combination of the gas flow and DC travelling potentials.

Ions may be selectively allowed to travel from this trapping region to the exit of the device by increasing the velocity of the DC travelling potentials or the rate at which the transient DC voltages are applied to the electrodes. The faster travelling DC potentials travel passed ions of relatively low mobility and so these ions are urged by the gas flow towards and out of the exit of the device. In contrast, the faster travelling DC potentials do not pass ions of higher mobility and drive these higher mobility ions towards the entrance, such that these ions remain trapped in the trapping region. The velocity of the DC travelling potentials may be increased with time, consequently causing ions of increasing ion mobility to be urged towards and out of the exit by the gas flow. Ions may therefore exit the device in ascending order of ion mobility.

The speed of the DC travelling potentials may be selected such that the separation device is operated either in a mode wherein ions are temporally separated primarily according to their ion mobility, or alternatively in a mode wherein ions are temporally separated primarily according to their mass or mass to charge ratio.

As described above, prior to analytical separation the DC travelling potentials are operated such that ions of a wide range of mobilities are driven against the flow of gas towards the entrance of the device so as to trap the ions in the vicinity of the entrance of the device. A DC barrier is provided at the entrance of the device so as to prevent the DC travelling potentials from driving the ions out of the entrance of the device.

FIG. 1B shows a schematic of the DC voltages that may be applied to the device of FIG. 1A at any one moment in time, as a function of position along the device. FIG. 1B also shows the position that the ions 12 take up during the ion trapping mode.

As described above, a DC potential barrier 10 is provided at the entrance of the device so as to provide a force on the ions that opposes that provided by the DC travelling potentials 4, and hence prevents the DC travelling potentials 4 from driving ions out of the ion entrance 1. During trapping of the ions, the DC travelling potentials 4 have an amplitude and velocity such that the time-averaged (mobility dependent) drift velocity imparted to the ions by the DC travelling potentials 4 exceeds the gas velocity and is in the opposite direction. The ions reach equilibrium when the time-averaged drift velocity, due to the combination of DC travelling potentials 4 and DC barrier 10, has the same magnitude and opposite direction to the velocity of the gas flow 5.

At the point where ions of a broad range of ion mobility are stationary, they are subject to opposing mobility dependent forces from the DC barrier 10 and DC travelling potentials 4, and therefore occupy substantially similar spatial positions along the device. However, as the relationship between ion mobility and ion velocity is not the same for a static DC barrier as compared to DC travelling potential 4, there is some separation of the ions along the length of the device based on the mobilities of the ions. The DC barrier 10 shown in FIG. 1B has a non-linear voltage gradient along the length of the trapping portion such that the electric field driving ions against the DC travelling potentials 4 is non-uniform. This allows ions 12 having a broad range of mobilities to be trapped along the barrier 10 with only a small spatial separation.

According to the above described trapping method the DC travelling potentials 4 must provide a high enough driving force to overcome the gas flow velocity, even for ions of the lowest ion mobility. As such, relatively high amplitude and/or slow speed DC travelling potentials 4 must be used. However, the combination of the DC barrier 10 with such high amplitude and/or slow speed DC travelling potentials 4 may cause high mobility ions to be driven towards the RF confining electrodes, resulting in dissociation of labile compounds and/or ions losses from the trapping region. Furthermore, as the spatial distribution of the ions along the ion trapping region is relatively small, space-charge distortion may occur when high ion populations are trapped. This may cause a degradation of the ion mobility resolution and/or ions losses due to the ions interacting with the RF confining field.

Various embodiments of the invention will now be described. Embodiments may have the features described above in relation to FIGS. 1A and 1B, except that the form of the DC travelling potentials 4 differs. Embodiments are also contemplated that the DC barrier 10 may not be present.

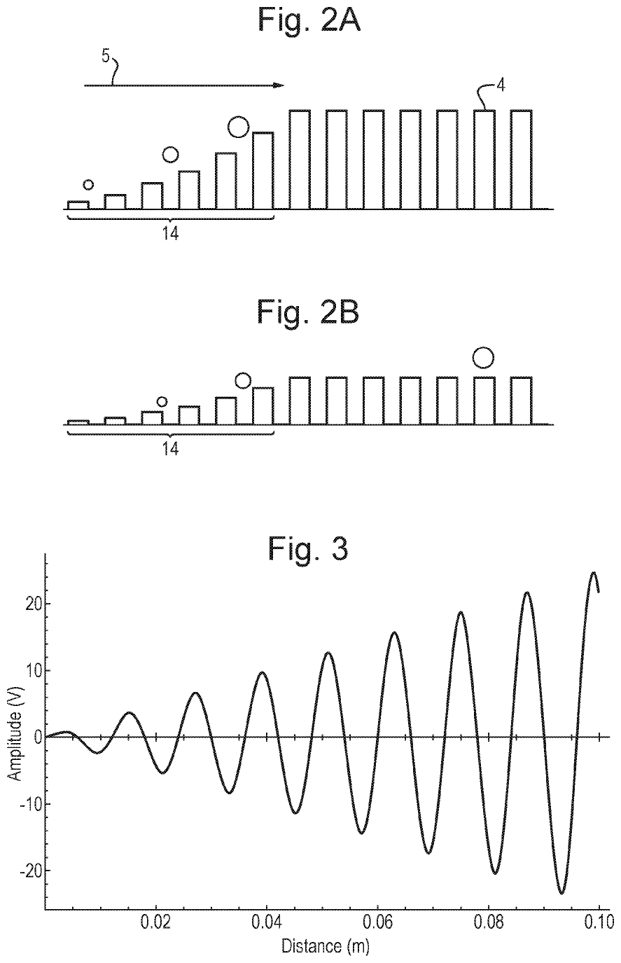

FIG. 2A shows a schematic of an embodiment representing the form of the DC travelling potentials 4 at an instant in time, as a function of position along the device, during an ion trapping mode in which ions are trapped near the entrance to the device. As can be seen in FIG. 2A, at any given time (at least during the ion trapping mode), the amplitudes of the DC travelling potentials 4 decrease over the length of an ion trapping region 14 in a direction from the exit towards the entrance. The DC travelling potentials 4 may have a higher amplitude downstream of the trapping region, and the DC travelling potentials 4 in this downstream region may have a uniform amplitude. Accordingly, as the DC travelling potentials 4 travel from the exit towards the trapping region 14 they initially maintain a constant amplitude. The amplitudes of the DC travelling potentials 4 then decreases or decays whilst the DC travelling potentials 4 enter and pass through the trapping region 14. The amplitude may decrease monotonically over the trapping region as a function of distance. A gas flow is provided through the device in the opposite direction to the DC travelling potentials 4, for urging ions towards the exit of the device.

During operation, ions enter the device (e.g. continuously) and experience a force towards the exit due to the gas flow and a force towards the entrance due to the DC travelling potentials 4. An ion of any given mobility reaches equilibrium and becomes trapped within the trapping region at a position where its time-averaged (mobility dependent) drift velocity caused by the DC travelling potentials 4 has the same magnitude but opposite sign to the gas velocity. For a fixed gas flow rate and DC travelling potentials 4 of fixed velocity and spatial frequency, ions of low mobility are trapped within the trapping region 14 at a position where the DC travelling potentials 4 are of relatively high amplitude, whereas ions of higher mobility are trapped at a position nearer to the entrance of the device where the amplitude of the DC travelling potentials 4 is lower. This is illustrated in FIG. 2A by the circles spaced apart within the trapping region 14, wherein larger circles represent lower mobility ions.

Ions of different ion mobility therefore become trapped in physically different positions along the length of the trapping region 14, since the amplitudes of the DC travelling potentials 4 vary along the trapping region 14. This spatial distribution of the ions leads to high space-charge capacity as compared to, for example, trapping the ions within a simple DC potential well. Also, as the DC travelling potentials 4 have relatively low amplitude as they approach the entrance of the device, high mobility ions are less likely to be driven such that they are lost to the system.

As described in relation to FIGS. 1A and 1B, in embodiments of the invention the ions may be confined in a direction orthogonal to the direction between the ion entrance and exit of the device, e.g. by application of an RF voltage to electrodes to produce a pseudo-potential confining force or by combination of pseudo potential and DC confining forces.

FIG. 2B shows a schematic representing the form of the DC travelling potentials 4 corresponding to that shown in FIG. 2A, except at a point in time when ions are being selectively released from the ion trapping region 14 towards the exit of the device. As can be seen in FIG. 2B, the amplitudes of the DC travelling potentials 4 have been reduced at each point along the length of the device. This reduces the time-averaged drift velocity caused by the DC travelling potentials 4 in the direction towards the entrance for ions of relatively low mobility, allowing the gas flow to force the ions towards and out of the exit of the device. However, the amplitude of the DC travelling potentials 4 remains sufficiently high to urge higher mobility ions towards the entrance with a time-averaged speed that matches the speed of the opposing gas flow at a location within the ion trapping region 14. These higher mobility ions therefore remain trapped in the ion trapping region 14. This is illustrated in FIG. 2B by the circles, wherein larger circles represent lower mobility ions.

Ions of different mobility may be selectively released from the ion trapping region 14 at different times by varying the properties of the DC travelling potentials 4. For example, the amplitude of the DC travelling potentials 4 at each point along the device may be decreased with time, and/or the speed that the DC travelling potentials 4 move along the device may be increased with time, such that ions of progressively higher mobility are released from the trapping region 14 and pass to the exit of the device. The properties of the DC travelling potentials 4 may be scanned or stepped with time such that ions of different mobilities may be scanned or stepped with time.

The ions released from the trapping region 14 may pass to one or more downstream device, which may include one or more of: an ion detector; an ion analyser; a mass analyser; a collision cell; a fragmentation cell; and a reaction cell.

An ion model is now described in order to illustrate the operational parameters useful to effect the above described ion trapping. In this model, the DC travelling potentials 4 are modeled in the form of a wave having an amplitude that varies sinusoidally along the position of the device, at any given time.

FIG. 3 shows an example of the form of the DC travelling wave used in the model, at one instance in time. The y-axis represents the DC voltage of the DC travelling wave and the x-axis represents the distance along the trapping region 14. As can be seen, the amplitude of the DC travelling wave is 0 V at the entrance end of the trapping region 14 and rises to an amplitude of 25 V (0-peak), over a distance of 10 cm. The wavelength of the sinusoidal DC travelling wave is 1.2 cm.

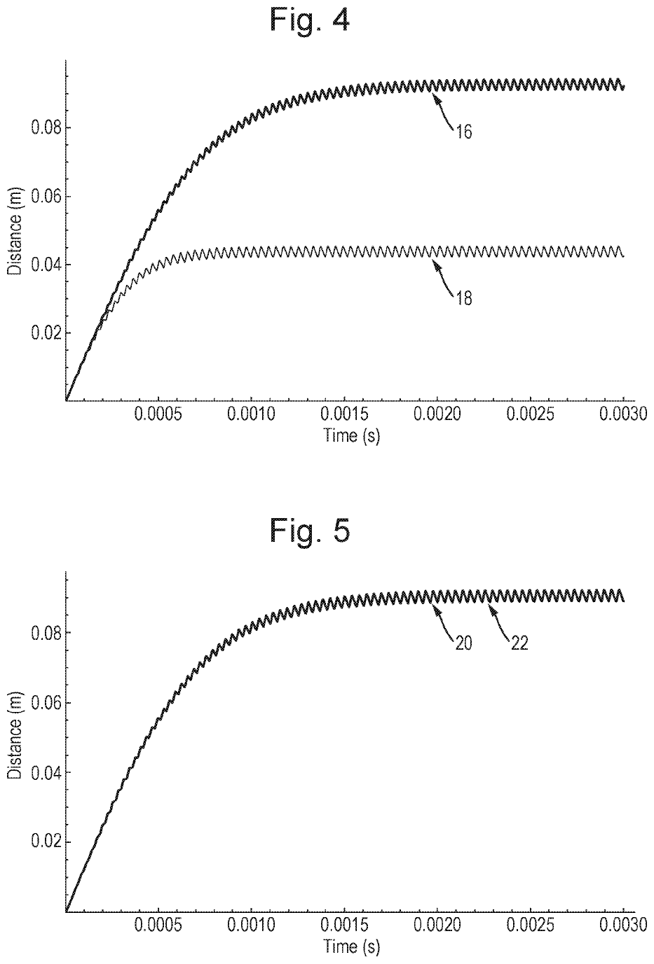

FIG. 4 shows two plots 16,18 for two different types of ions, wherein each plot represents the positions of the ions within the device according to the above described embodiments as a function of time after the ions enter the device. In these simulations, the ions were considered to enter the device at a position of 0 m. The gas within the device was modeled as nitrogen gas at a pressure of 3 mbar and a temperature of 300 K, with a gas flow speed from the entrance to the exit of the device of 125 m/s. A DC travelling wave having the amplitude profile (as a function of position) shown in FIG. 3 was modeled as travelling towards the ion entrance at a velocity of 300 m/s. The DC travelling wave was therefore considered to reduce in amplitude as it traveled towards the entrance to an amplitude of 0 V at the entrance.

The upper plot in FIG. 4 represents the position of a first species of ion 16 within the device as a function of time, wherein the first species has a mass to charge ratio value of 1012.5 and a collision cross section value of 306 Å². This corresponds to the literature value of the [M+H]+ ion of polyalanine with 14 Alanine sub units. The lower plot in FIG. 4 represents the position of a second species of ion 18 within the device as a function of time, wherein the second species has a mass to charge ratio value of 231.1 and a collision cross section of 151 Å². This corresponds to the literature value of the [M+H]+ ion of polyalanine with 3 Alanine sub units.

It can be seen from FIG. 4 that as time increases the ions are moved away from the entrance of the device by the combination of the gas flow and DC travelling wave. The time-averaged position at which each species is located moves away from the entrance relatively quickly as a function of time and then stabilises at an equilibrium position within the device. More specifically, species 18 is driven away from the entrance for a period of 1 ms, at which point the ions 18 stabilise at an equilibrium position located 4 cm from the entrance of the device. Similarly, species 16 is driven away from the entrance for a period of 2 ms, at which point the ions 16 stabilise at an equilibrium position located 9 cm from the entrance of the device. In this example, species 16 has a lower mobility than species 18 and so a larger amplitude DC potential is required to counter-balance the gas flow for species 16 than for species 18. As such, species 16 stabilises further away from the entrance than species 18, where the DC amplitude is higher. This demonstrates that a wide range of mobilities may be trapped using the techniques disclosed herein and that a population of ions having a broad range of ion mobilities can be spread over a relatively large region, thus alleviating potential space-charge problems.

As seen from FIG. 4, although the ions have a time-averaged movement away from the entrance of the device until they reach their respective equilibrium positions, the ions do not continually move away from the entrance of the device. Rather, the ions oscillate away and towards the entrance, as shown by the ripple in each plot. This is due to the way in which the DC travelling wave drives ions towards the entrance. The absolute amplitude of oscillation may be the same for ions of any ion mobility and for ions trapped at different positions.

Techniques are disclosed herein for separating ions predominantly according to ion mobility or predominantly according to mass to charge ratio, or according to a mixture of ion mobility and mass to charge ratio, by selecting the DC travelling wave parameters.

FIG. 5 shows two plots obtained using the same parameters as those used to generate the plots in FIG. 4, except that different species of ion to those in FIG. 4 are modeled. One plot in FIG. 5 represents the position of a first species of ion 20 within the device as a function of time, wherein the first species 20 has a mass to charge ratio value of 900 and a collision cross section value of 300 Å². The other plot in FIG. 5 represents the position of a second species of ion 22 within the device as a function of time, wherein the second species has a mass to charge ratio value of 800 and a collision cross section value of 300 Å². The species modeled therefore had the same collision cross section, but different mass to charge ratios. The two plots in FIG. 5 overlap, which demonstrates that under the conditions modeled, the motion of the ions is dominated by the collision cross section of the ions and not by the mass to charge ratio.

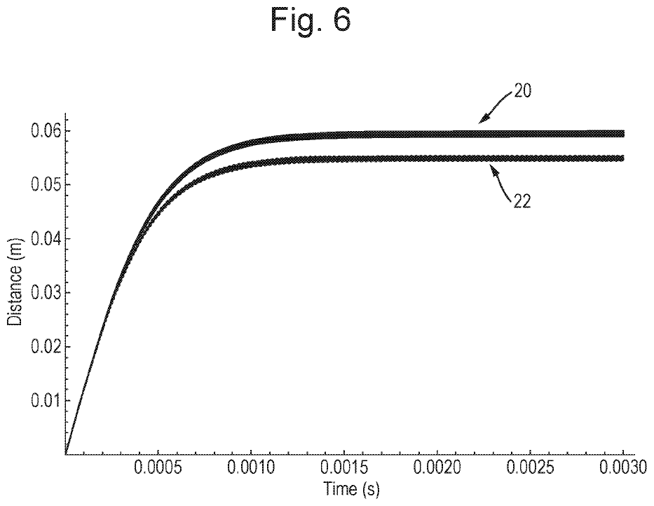

FIG. 6 shows two plots obtained using the same species and parameters as those used to generate the plots in FIG. 5, except that the speed of the DC travelling wave was modeled as being increased to 6000 m/s and the maximum amplitude in the trapping region was modeled as being increased to 200 V (0-peak). In contrast to FIG. 5, it can be seen from FIG. 6 that the two different species of ions 20,22 were driven to different equilibrium positions within the trapping region. As the two species of ions 20,22 have the same cross section area, it can be seen that in this mode the device separates the ions according to their mass to charge ratios. The device may therefore be considered to be operating in a mixed mobility and mass to charge ratio separation mode of operation. Subsequent separation, effected by changing the DC travelling wave parameters, will also be of mixed mass to charge ratio and mobility characteristic. In this case, these two species would be separated during an analytical cycle, whereas ion mobility alone would fail to separate the different species.

The embodiments of the invention use DC travelling waves having operational parameters that may be varied with time so as to separate ions primarily according to mobility, or primarily according to mass to charge ratio, or according to a mixture of mass to charge ratio and mobility. This is quite different to prior art techniques that drive ions using a gas flow and a static DC gradient and/or a potential barrier opposing the motion of the ions. Such techniques cannot operate in the multiple modes according to the embodiment so of the invention and are limited to mobility separation.

As described above, e.g. in relation to FIGS. 2A and 2B, the device may comprise a second region downstream of the trapping region 14, through which the DC travelling potentials/wave 4 travel towards the trapping region 14. The DC travelling potentials/wave 4 in this downstream region may have a uniform amplitude. The amplitudes of the DC travelling potentials/wave 4 in the second region may be reduced in order to allow ions leaving the trapping region to exit the device downstream of the second region.

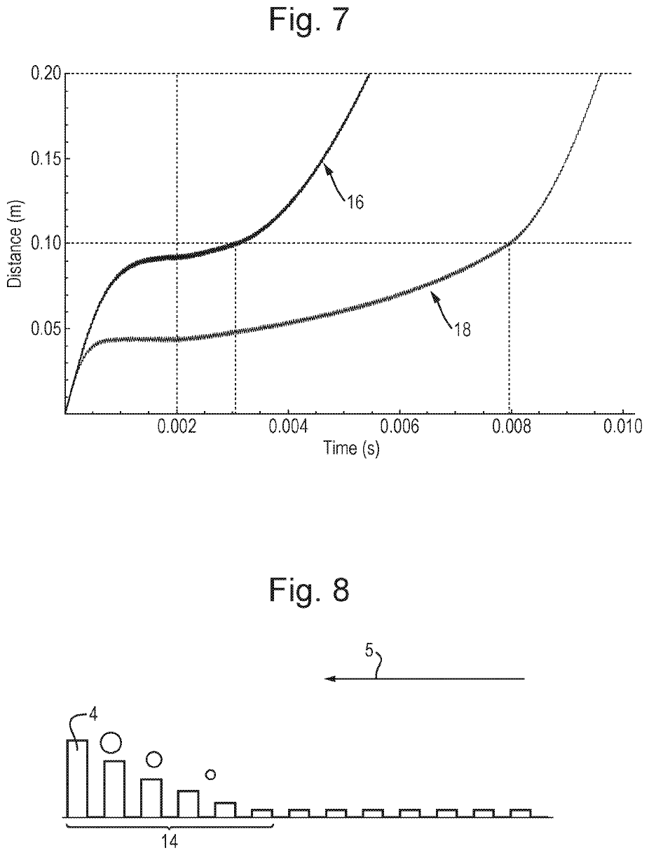

FIG. 7 shows a simulation of an embodiment corresponding to that of FIG. 4, except that there is further provided said second region downstream of the trapping region 14 (through which the DC travelling wave travels) and the amplitude of the DC wave is scanned with time so as to eject ions from the device. Accordingly, FIG. 7 shows two plots 16,18 for two different types of ions, wherein each plot represents the positions of the ions within the device as a function of time after the ions enter the device. The gas type, velocity, pressure, temperature, and the initial DC travelling wave conditions were the same as those described above in relation to FIGS. 3 and 4. The length of the trapping region was modeled as being 10 cm long. The second downstream region was modeled as being 10 cm long, giving the device a total length of 20 cm. The DC travelling wave was modeled as having a maximum amplitude that was constant along the second region.

As described in relation to FIG. 4, the two species of ions 16,18 were allowed to reach equilibrium position along the trapping region 14, taking 2 ms for the lower mobility ions. After 2 ms, the amplitude of the DC travelling wave was scanned down from the starting amplitude profile to 0 V across the length of the device. The amplitude was scanned down over a period of 10 ms. As can be seen from FIG. 7, lower mobility species 16 exited the trapping region 14 after approximately 3 ms, whereas higher mobility species 18 exits the trapping region after approximately 8 ms. Accordingly, the different species of ions exit the device separated in time. The separation in time, and thus ion mobility resolution or mass to charge ratio resolution, may be arbitrarily increased by slowing down the rate of the amplitude scan.

FIG. 8 shows a schematic of a less preferred embodiment in which directions of the gas flow and DC travelling waves are reversed, i.e. the gas flows in the direction from the exit of the device towards the entrance, and the DC travelling potentials 4 travel in the direction from the entrance to the exit of the device. FIG. 8 shows the form of the DC travelling potentials 4 at an instant in time, as a function of position along the device, during an ion trapping mode in which ions are trapped near the entrance to the device. As can be seen in FIG. 8, at any given time (at least during the ion trapping mode), the amplitudes of the DC travelling potentials 4 decrease over the length of an ion trapping region 14 in a direction from the entrance towards the exit. The DC travelling potentials 4 may have a lower amplitude (or zero amplitude) downstream of the trapping region 14, and the DC travelling potentials 4 in this downstream region may have a uniform maximum amplitude. Accordingly, as the DC travelling potentials 4 travel from the entrance towards the exit of the trapping region 14, the amplitudes of the DC travelling potentials 4 decrease or decay. The amplitude may decrease monotonically over the trapping region 14 as a function of distance. A gas flow is provided through the device in the opposite direction to the DC travelling potentials 4, for urging ions towards the entrance of the device.

During operation, ions enter the device (e.g. continuously) and experience a force towards the exit due to the DC travelling potential 4 and a force towards the entrance due to the gas flow 5. As described in the embodiments above, an ion of any given mobility reaches equilibrium and becomes trapped within the trapping region 14 at a position where its time-averaged (mobility dependent) drift velocity caused by the DC travelling potentials 4 has the same magnitude but opposite sign to the gas velocity. For a fixed gas flow rate and DC travelling potentials 4 of fixed velocity and spatial frequency, ions of low mobility are trapped within the trapping region 14 at a position where the DC travelling potentials 4 are of relatively high amplitude, whereas ions of higher mobility are trapped at a position nearer to the exit of the device where the amplitude of the DC travelling potentials 4 is lower. This is illustrated in FIG. 8 by the circles spaced apart within the trapping region 14, wherein larger circles represent lower mobility ions.

Ions of different ion mobility therefore become trapped in physically different positions along the length of the trapping region 14, since the amplitudes of the DC travelling potentials 4 vary along the trapping region 14. This spatial distribution of the ions leads to high space-charge capacity.

As described in relation to FIGS. 1A and 1B, in embodiments of the invention the ions may be confined in a direction orthogonal to the direction between the ion entrance and exit of the device, e.g. by application of an RF voltage to electrodes to produce a pseudo-potential confining force or by combination of pseudo potential and DC confining forces.

In order to eject ions from the embodiment of FIG. 8, the amplitudes of the DC travelling potentials 4 may be increased at each point along the length of the device. This increases the time-averaged drift velocity of the ions caused by the DC travelling potentials 4 in the direction towards the exit for ions of relatively high mobility, allowing the ions to be urged against the gas flow and out of the exit of the device. However, the amplitude of the DC travelling potentials 4 remains sufficiently low that lower mobility ions are urged towards the exit with a time-averaged speed that matches the speed of the opposing gas flow at a location within the ion trapping region 14. These lower mobility ions therefore remain trapped in the ion trapping region 14.

Ions of different mobility may be selectively released from the ion trapping region 14 at different times by varying the properties of the DC travelling potentials 4. For example, the amplitude of the DC travelling potentials 4 at each point along the device may be increased with time, and/or the speed that the DC travelling potentials 4 move along the device may be decreased with time, such that ions of progressively higher mobility are released from the trapping region 14 and pass to the exit of the device. The properties of the DC travelling potentials 4 may be scanned or stepped with time such that ions of different mobilities may be scanned or stepped with time.

The ions released from the trapping region 14 may pass to one or more downstream device, which may include one or more of: an ion detector; an ion analyser; a mass analyser; a collision cell; a fragmentation cell; and a reaction cell.

Although the present invention has been described with reference to various embodiments, it will be understood by those skilled in the art that various changes in form and detail may be made without departing from the scope of the invention as set forth in the accompanying claims.

For example, there are a number of ways in which the space-charge capacity, and hence the analytical performance of the device may be increased. The trapping region of the ion separator may be axially extended such that ions of differing mobility are spread over a larger axial distribution within the trapping region. The use of transient DC potentials is particularly advantageous in this case, e.g. compared to using a DC gradient to urge ions against the gas flow, as the maximum absolute voltage required for each transient DC potential does not increase as the axial length of the trapping region is increased. In contrast, if a DC gradient was used to oppose the gas flow, the DC potential difference required to maintain a given DC gradient would need to increase as the trapping region is made longer. This may be impractical and may, for example, lead to an electrical breakdown.

Although the device has been described as being constructed from a stacked ring ion guide of apertured electrodes, it is contemplated that other forms of ion guide may be used, e.g. a segmented multipole ion guide may be used.

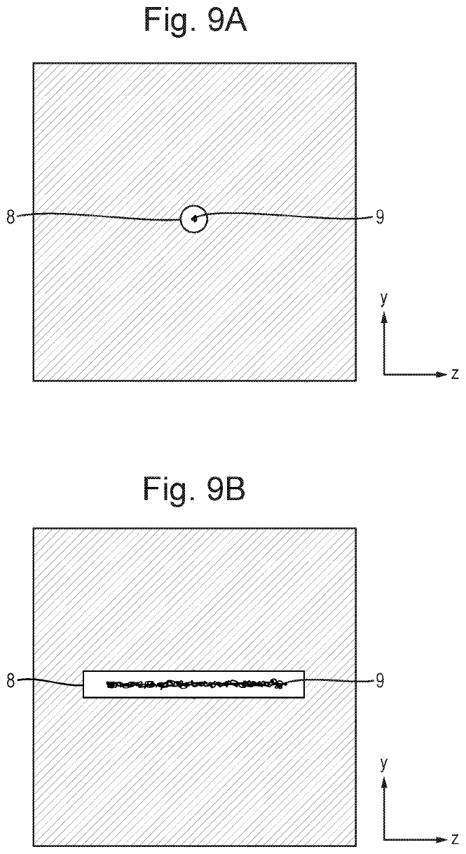

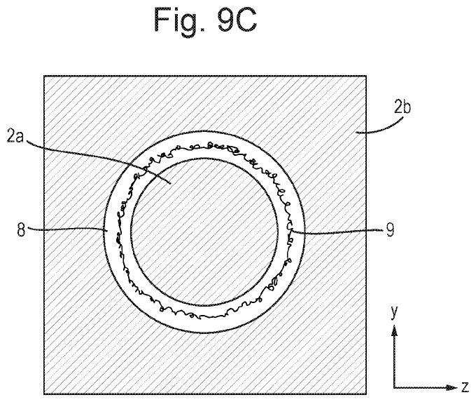

FIG. 9A shows a schematic of one of the electrodes 1-3 in the arrangement of FIG. 1A (in the x-y plane), and which may also be used in embodiments of the present invention. In these embodiments, the aperture 8 in each electrode in which ions 9 are confined radially may be circular. A series of such electrodes may be used to form the device described herein, wherein adjacent electrodes may be supplied with opposite phases of an RF or AC voltage in order to radially confine the ions. In order to increase the space-charge capacity of the device, the size of the aperture 8 in the electrode may be extended or elongated in a direction orthogonal to the longitudinal axis of the device. For example, the aperture 8 in each electrode may be oval or a rectangular slot, the latter being shown in FIG. 9B. This allows the ions 9 to be confined over a relatively large space in the dimensions orthogonal to the longitudinal axis of the device, thus increasing the space-charge capacity of the device.

FIG. 9C shows a schematic of the electrode structure of another embodiment (in the x-y plane) in which the apertured electrode 1-3 has an inner electrode 2a arranged within the aperture 8 of an outer electrode 2b. In the depicted embodiment the outer electrode 2b has a circular aperture and the inner electrode 2a is circular. However, the aperture 8 and/or inner electrode 2a may be other shapes. Such embodiments confine ions in an annular or other tubular-shaped volume, which allows a relatively large and stable confinement volume.

In the embodiments having electrode structures that define non-cylindrical ion confinement regions, such as FIGS. 9B and 9C, a device may be arranged upstream of the ion confinement region that is configured to convert the ion beam travelling downstream to a shape and/or size for the ion confinement region. Additionally, or alternatively, a device arranged may be arranged downstream of the ion confinement region and configured to convert the ion beam travelling in the downstream direction from the shape and/or size it is within the ion confinement region to another shape and/or size, e.g. so as to have a circular and/or smaller cross-section. Several such ion manipulation devices are known and will not be described further herein.

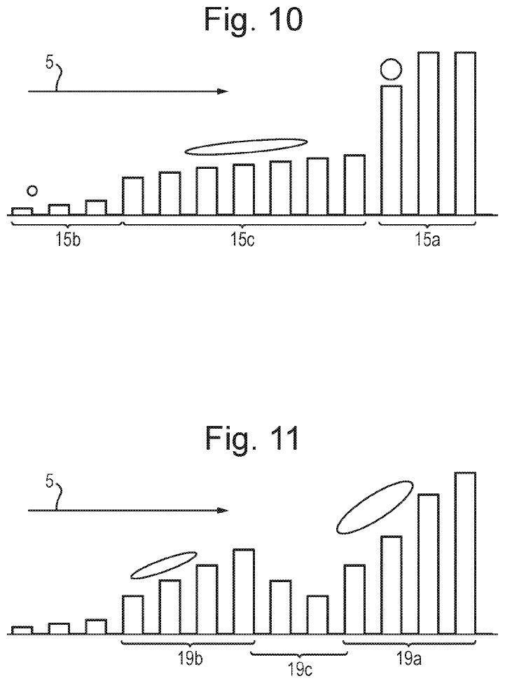

Other embodiments are contemplated for extending the space-charge capacity, such as those of FIGS. 10 and 11.

FIG. 10 shows a schematic of an embodiment that may be used, for example, for extending the space-charge capacity for a subset of targeted ions with a specified, narrow range of ion mobilities. FIG. 10 represents the form of the DC travelling potentials 4 at an instant in time, as a function of position along the device, during an ion trapping mode. The gas flow 5 opposes the motion of the ions due to the DC travelling potentials 4, as described in the embodiments above. This embodiment corresponds to that of FIG. 2A in that the amplitudes of the DC travelling potentials 4 decrease over the length of an ion trapping region 14 in a direction from the exit towards the entrance. However, in the embodiment of FIG. 10 the amplitudes do not decrease at a constant rate (with respect to distance) within the trapping region 14. Rather, the trapping region 14 comprises a first and second lengths 15a,15b in which the rate that the amplitudes decrease is relatively high (with respect to distance along the device), and a third length 15c in which the rate that the amplitudes decrease is relatively low (with respect to distance along the device). The third length 15c may be longer than the first and/or third length 15a,15b. The device may be configured to operate such that ions of a specific mobility range become trapped in this third length 15c, and may therefore be distributed over a large axial extent. In contrast, ions of higher and lower mobility will take up positions along the first and second lengths 15a,15b and may therefore be compressed into a smaller axial distribution. In this way, the space-charge capacity for ions within a targeted mobility range can be increased. It will be appreciated that other embodiments are contemplated in which one of the first and second lengths 15a, 15b may be omitted.

FIG. 11 shows a schematic of an embodiment that may be used, for example, to partition the population of ions with respect to ion mobility along the length of the device in discrete regions. This can be used to physically separate mobility ranges with high charge-density from regions with lower-charge density. FIG. 11 represents the form of the DC travelling potentials 4 at an instant in time, as a function of position along the device, during an ion trapping mode. The gas flow 5 opposes the motion of the ions due to the DC travelling potentials 4, as described in the embodiments above. This embodiment corresponds to that of FIG. 2A in that the amplitudes of the DC travelling potentials 4 decrease over the length of the device in a direction from the exit towards the entrance, over at least part of the device. However, in the embodiment of FIG. 11 the amplitudes do not decrease monotonically within the trapping region 14. Rather, the trapping region 14 comprises first and second lengths 19a,19b in which the amplitudes decrease along the device, and a third length 19c between the first and second lengths in which the amplitudes increase along the device. Ions with mobility within a first range become trapped along the second length 19b, where the amplitudes may change monotonically. In region 19c the amplitudes increase, allowing a population of ions with lower ion mobility to be accelerated in this region by the gas flow and enter length 19a, where the amplitude may again decrease monotonically (although from a higher value than in length 19b). Ions of lower mobility become trapped along this length 19a and separated from ions within length 19b by the length 19c. Ions may be scanned out of lengths 19a,19b separately or simultaneously e.g. using the ejection methods disclosed herein.

According to the various embodiments having longitudinally segmented ion guiding structures, the DC travelling wave (e.g. sinusoidal wave) may be produced by applying different phases of an AC or RF voltage to the various segments. For example, the DC travelling wave may be produced by applying voltages to adjacent segments which are 90 degrees (or other angles) out of phase.

The ion guide structure described has a linear longitudinal ion guiding axis between the entrance and exit. However, alternatively, the ion guide may provide a non-linear ion guiding longitudinal axes between the entrance and exit.

Although the maximum amplitudes of the DC travelling potentials/wave in the second region downstream of the ion trapping region have been described as being uniform, it is contemplated that these maximum amplitudes (at any given time) may vary along the length of the second region in a non-uniform manner. For example, the maximum amplitudes (at any given time) may increase (e.g. slightly) in amplitude from the entrance to the exit, and/or may decrease from the entrance to the exit.

Although the gas flow has been described hereinabove as being a constant speed, it is contemplated that the gas flow speed may be varied with time in order to scan different ions out of the device at different times. For example, in embodiments wherein the gas flow is directed towards the exit (e.g. FIGS. 2A-2B), the gas flow rate may be increased with time so as to drive ions out of the exit such that the mobility of ions that exit decreases as a function of time. Alternatively, in embodiments wherein the gas flow is directed towards the entrance (e.g. FIG. 8), the gas flow rate may be decreased with time so that ions are driven out of the exit such that the mobility of ions that exit decreases as a function of time.

It is contemplated that the gas flow rate may be varied as described above so as to selectively eject ions with or without varying the parameters of the DC travelling potentials/wave as a function of time.

It is contemplated herein that in less preferred embodiments the gas flow may be replaced by another ion driving mechanism. For example, the gas flow may be replaced by a DC field such as a static DC voltage field or gradient. In such embodiments the trapping of ions with a broad range of ion mobility can be achieved with a constant DC field in one direction and an opposing travelling potential. The operational parameters of the traveling potentials may vary along the device as described above. Alternatively, the magnitude of the DC field may vary along the device and the operational parameters of the travelling potentials may be invariant. Alternatively, both the DC field and the travelling potential operational parameters may vary along the device.

Embodiments are contemplated wherein a second, separate trapping region is provided upstream of the above-described device (first trapping region). In these embodiments, a second population of ions may be accumulated in the second trapping region whilst a first population of ions are separated and trapped in the above-described first trapping region. The second trapping region may operate in the same manner as the first trapping region so as to separate and trap the first population of ions. This dual trapping arrangement allows operation of the device with up to 100% duty cycle.

It is alternatively contemplated that the second trapping region may be any type of ion trap that pulses ions into the first trapping region.

Embodiments have been described in which the amplitude of the travelling DC potential varies as a function of position along the device such that ions of different mobility become trapped within a trapping region at different locations along the device. However, it is contemplated that one or more operational parameter of the travelling DC potential other than amplitude may be varied as a function of position along the device such that ions of different mobility become trapped within a trapping region at different locations along the device. For example, the frequency with which the travelling potentials pass along the device may vary as a function of position along the device. Alternatively, or additionally, the duty cycle and/or length of the travelling potentials may vary along the device. Alternatively, or additionally, the shape of the travelling potentials may vary along the device.

As described above, at least one operational parameter (e.g. amplitude) of the travelling DC potentials is varied as a function of position along the device such that ions of different mobility become trapped within a trapping region at different locations along the device. Ions may elute from an upstream device (such a chromatographic device) separated according to their ion mobility and pass into the trapping device. If a range of ion mobilities of interest, at a particular chromatographic elution time, is known, the at least one parameter of the transient DC potentials may be altered/selected based on the elution time, e.g. to achieve optimum separation of these ions and/or to minimise distortions due to space-charge effects at this specific chromatographic elution time. The desired operational parameter(s) of the travelling DC potentials may be determined in advance, e.g. from a survey scan such as during a single analytical separation by a data dependent method, or may be determined during a previous analytical separation and stored as a pre-determined list linked to the known elution times. The desired operational parameter(s) of the travelling DC potentials for trapping and/or releasing the ions may then be selected to optimise the performance of a downstream device that may be operated in synchronism with the ion mobility separation, such as a quadrupole mass filter or time of flight mass analyser.

A mass filter, e.g. a quadrupole or other multipole mass filter, may be provided downstream of the ion trapping device. A fragmentation or reaction device may be arranged downstream of the mass filter for producing fragment or product ions, and a mass analyser may be provided downstream of the fragmentation or reaction device. This arrangement may be used to improve the duty cycle of the mass filter, as will be appreciated from the following. The arrangement may be operated in a data-dependent mode of operation. A survey scan may be acquired in which ions from the chromatographic separation device are trapped in the trapping region and then ejected from the trapping region in an ion mobility dependent manner as described herein, whilst operating the mass filter in a non-mass resolving mode (or in a wide m/z bandpass mode), and bypassing the fragmentation or reaction device or operating it so as to not fragment or react ions. The survey scan provides two dimensional data that correlates ion mobility elution time from the trapping region with the m/z values detected. This data may then be used to select one or more of the temporally separated ion species, and determine their ion mobility retention time and m/z value. In a subsequent experiment cycle, the mass filter may be controlled based on the data from the survey scan so as to only transmit the selected ion species. For example, the mass filter may be synchronised with the ion mobility elution time from the trapping region such that the mass to charge ratio(s) able to be transmitted by the mass filter is varied based on the ion mobility elution time from the survey scan (or from a time calculated from the survey scan elution time if the conditions in the trapping region have changed) so as to only transmit the selected ion species. The selected species that are transmitted by the mass filter may then be dissociated or reacted in the downstream fragmentation or reaction device and mass analysed by the mass analyser. The fragment or product ions detected may be correlated to their precursor ions using known techniques, e.g. based on their time of detection and/or by matching detected intensity profiles of the fragment or product ions with intensity profiles of precursor ions.

This method increases the duty cycle of the mass filter and adds specificity when analysing a plurality of different ion species with the same or similar retention time in the chromatographic separation device.

A targeted mode of operation is also contemplated in which the chromatographic retention time, elution time from the trapping region and mass to charge ratio value for one or more target ion is recorded using one or more standard in a previous experiment or in a method development step. The ion mobility separation conditions in the trapping region and the operation of the mass filter may then be pre-programmed so as to optimise the mass filter duty cycle and improve specificity.

Embodiments are contemplated wherein an electrostatic gate or deflection lens is arranged downstream of the ion trapping region. The gate or lens may be controlled so as to selectively block or deflect ions leaving the ion trapping region. This allows ions within one or more ion mobility range to be onwardly transmitted, while rejecting or removing ions outside that mobility range. The onwardly transmitted ions may then be, for example, activated, reacted dissociated or analysed.

Embodiments are contemplated in which two or more ion separators, each having a trapping region as described herein, are arranged in series to perform an IMS-IMS analysis. In one mode of operation a first ion mobility range may be selected to be onwardly transmitted from the first ion separator. These ions may then be activated, reacted or dissociated before accumulation and subsequent mobility separation in the second downstream ion separator.

Alternatively, the combination of two ion separators in series may be used to mitigate degradation of performance (of a single ion separator) due to excessive space-charge or by exceeding the dynamic range of the detection system. A selected ion population may be temporally separated by the first ion separator. Ions of interest may be allowed to pass from the first ion separator into the second ion separator, whereas ions from other species may be attenuated or prevented from entering the second ion separator.

In embodiments where two or more ion separators are arranged in series the devices may reside within the same vacuum region of an instrument, e.g. such that the composition of the buffer gas and pressure within the ion separators may be substantially the same. Alternatively, the ion separators may be arranged in separate vacuum regions, which may have separate pumping arrangements and may be separated by a differential pumping aperture. This allows the composition, pressure, and flow characteristics of the buffer gas in the ion separators to be controlled substantially independently for each ion separator.

Embodiments are contemplated in which selected ions exiting the ion separator are activated, reacted or dissociated in a downstream device. The product or fragment ions may then be driven back into the ion separator and separated according to ion mobility using the techniques described herein. These ions may then be ejected from the ion separator in an ion mobility dependent manner, for example, onto a detector or into a mass analyser. Alternatively, the selected ones of the ejected ions may be activated, reacted or dissociated in a downstream device. The resulting product or fragment ions may then be driven back into the ion separator and separated according to ion mobility using the techniques described herein. These ions may then be ejected from the ion separator in an ion mobility dependent manner, for example, onto a detector or into a mass analyser. This process may be repeated any number of times to obtain and/or analyse product or fragment ions of any desired generation.

1. A method of separating ions comprising:
providing an ion separation device comprising a plurality of electrodes;
providing a gas flow so as to urge ions in a first direction along the device;
applying voltages to said electrodes so that a plurality of travelling potentials move along the device and urge the ions in a second direction opposite to the first direction whilst the ions are being urged by the gas in the first direction, wherein at least one operational parameter of the travelling potentials is varied as a function of position along the second direction such that ions of different mobility or mass to charge ratio become trapped within a trapping region at different locations along the second direction; and
sequentially releasing ions from said trapping region in increasing order of ion mobility or mass to charge ratio, or in decreasing order of ion mobility or mass to charge ratio.

2. The method of claim 1, wherein one of the at least one operational parameters is the maximum amplitude of the travelling potentials, which reduces or increases as the potentials move along the device in the second direction.

3. The method of claim 2, wherein a plurality of travelling potentials having different maximum amplitudes are simultaneously located along the trapping region.

4. The method of claim 3 or 4, wherein the maximum amplitude of the travelling potentials reduces or increases monotonically as the potentials move along the device in the second direction.

5. The method of any preceding claim, wherein:
(i) one of the at least one operational parameters is the speed of the travelling potentials, which increases or decreases as a function of position along the device in the second direction; and/or
(ii) one of the at least one operational parameters is the frequency with which the travelling potentials pass along the device, which increases or decreases as a function of position along the device in the second direction; and/or
(iii) one of the at least one operational parameters is the duty cycle and/or length of the travelling potentials in the second direction, which increases or decreases as a function of position along the device in the second direction; and/or
(iv) one of the at least one operational parameters is the shape of the travelling potentials, which changes as the potentials move along the device in the second direction.

6. The method of any preceding claim, wherein said step of applying voltages comprises applying DC transient voltages to the electrodes and wherein the travelling potentials are DC travelling potentials.

7. The method of any preceding claim, wherein said step of urging ions in the first direction and the step of providing the travelling potentials cause ions to become trapped so that the mobilities or the mass to charge ratios of the ions either increase or decrease with increasing position in the second direction.

8. The method of any preceding claim, wherein said step of sequentially releasing ions is performed by increasing or decreasing the gas flow rate as a function of time such that the ions are sequentially released from said trapping region at different times and in order of ion mobility or mass to charge ratio, or in reverse order of ion mobility or mass to charge ratio.

9. The method of any preceding claim, wherein said step of sequentially releasing ions is performed by reducing or increasing the maximum amplitude of the travelling potentials as a function of time and so that the maximum amplitude occurring at a given location along the trapping region is reduced or increased with time respectively.

10. The method of any preceding claim, wherein said step of sequentially releasing ions is performed by any one or more of:
(i) reducing or increasing the speed of the travelling potentials as a function of time such that the speed occurring at a given location along the trapping region is reduced or increased with time respectively; and/or
(ii) reducing or increasing the frequency with which the travelling potentials pass along the device as a function of time such that the frequency occurring at a given location along the trapping region is reduced or increased with time respectively; and/or
(iii) reducing or increasing the duty cycle and/or length of the travelling potentials in the second direction as a function of time so that the duty cycle and/or length occurring at a given region along the trapping region is reduced or increased with time respectively; and/or
(iv) varying the shape of the travelling potentials occurring at a given region along the trapping region as a function of time.

11. The method of any preceding claim, comprising providing a DC or pseudo-potential barrier at an ion entrance end and/or ion exit end of the trapping region.

12. The method of any preceding claim, comprising confining ions orthogonally to the first and second directions, optionally by applying AC or RF voltages to electrodes.

13. The method of any preceding claim, comprising performing a first mode of operation in which said travelling potentials are translated along the trapping region with a first speed so as to cause ions to be separated according to their ion mobilities; and
performing a second mode of operation in which said travelling potentials are translated along the trapping region with second speed that is higher than said first speed so as to cause ions to be separated according to their mass to charge ratios.

14. A method of mass and/or ion mobility spectrometry comprising:
separating ions according to the method of any preceding claim; and
detecting, filtering or mass analysing the ions released from the trapping region.

15. A separation device for separating ions, comprising:
a plurality of electrodes;
one or more voltage supplies;
a first ion urging device configured and set up to provide a gas flow for urging ions in a first direction along the device; and
a controller configured and set up to control the one or more voltage supplies so as to apply voltages to said electrodes so that, in use, a plurality of travelling potentials move along the device and urge ions in a second direction opposite to the first direction whilst the ions are being urged by the gas flow in the first direction, wherein the controller is configured and set up to vary at least one operational parameter of the travelling potentials as a function of position along the second direction such that, in use, ions of different mobility or mass to charge ratio become trapped within a trapping region at different locations along the second direction.

16. The device of claim 15, wherein the controller is configured and set up to vary the gas flow and/or operational parameter with time so as to sequentially release ions from said trapping region in increasing order of ion mobility or mass to charge ratio, or in decreasing order of ion mobility or mass to charge ratio.

17. A mass spectrometer and/or ion mobility spectrometer comprising:
a separation device as claimed in claim 15 or 16, wherein the controller is configured and set up to release or eject ions from the trapping region; and
a detector, ion filter or mass analyser arranged to detect, filter or mass analyse the ions.

18. A separation device for separating ions, comprising:
a plurality of electrodes;
one or more voltage supplies; and
a controller configured and set up to control the one or more voltage supplies so as to apply voltages to said electrodes so that, in use, a DC voltage gradient or DC electric field urges ions in a first direction along the device and a plurality of travelling potentials move along the device and urge ions in a second direction opposite to the first direction whilst the ions are being urged by the DC voltage gradient or DC electric field in the first direction;
wherein the controller is configured and set up to vary the magnitude of the DC voltage gradient or DC electric field as a function of position along the first direction and/or to vary at least one operational parameter of the travelling potentials as a function of position along the second direction, such that in use ions of different mobility or mass to charge ratio become trapped within a trapping region at different locations along the second direction.

19. A method of separating ions comprising:
providing an ion separation device as claimed in claim 18;
providing a DC voltage gradient or DC electric field so as to urge ions in a first direction along the device;
applying voltages to said electrodes so that a plurality of travelling potentials move along the device and urge the ions in a second direction opposite to the first direction whilst the ions are being urged by the DC voltage gradient or DC electric field in the first direction;
wherein the magnitude of the DC voltage gradient or DC electric field is varied as a function of position along the first direction and/or wherein at least one operational parameter of the travelling potentials is varied as a function of position along the second direction, such that ions of different mobility or mass to charge ratio become trapped within a trapping region at different locations along the first and second directions; and
sequentially releasing ions from said trapping region in increasing order of ion mobility or mass to charge ratio, or in decreasing order of ion mobility or mass to charge ratio.
